(19) United States
(12) Patent Application Publication
(10) Pub. No.: US 2007/0199349 A1
(43) Pub. Date: Aug. 30, 2007

(54) Compound Glass Bowing

(75) Inventors: Nerio Lucca, Jumet (BE); Philippe Bonvalet, Jumet (BE)

Correspondence Address: AKERMAN SENTERFITT, P.O. BOX 3188, WEST PALM BEACH, FL, 33402-3188, US

(73) Assignee: Glaverbel, Brussells (BE)

(21) Appl. No.: 10/574,557

(22) PCT Filed: Sep. 30, 2004
(86) PCT No.: PCT/EP04/52386

§ 371 Date: Mar. 2, 2007

(30) Foreign Application Priority Data
Oct. 3, 2003 (BE) 2003/0518

(51) Int. Cl. C03C 27/02

(52) U.S. Cl. 65/59.1

(57) ABSTRACT

The invention relates to compound glass bowing. Said invention bowing is carried out on a frame, one of the foils being at least provided with non-presintered enamel composition patterns, the other foil being provided with functional layers. Said enamel patterns and functional layers are jointed to each other on the surfaces of the foils. Said invention is characterized in that during the transfer of the foils to a bowing furnace, they are primarily arranged one upon the other in such a way that a space is maintained therebetween at least during a time period corresponding to sintering by temperature increase, and afterwards before a softening point is attained, they are applied to each other for the remaining bowing time.

The present invention relates to the bending of compound glazing units and in particular glazing units comprising thin functional layers.

The bending of compound glazing units such as windscreens is most frequently carried out with flat sheets being disposed on frames or moulds, the configuration of which corresponds to the peripheral profile of the bent glazing. The sheets disposed on these frames are passed into an oven, where they are brought to softening temperature. They are deformed by gravity pressing against the support mould, which provides them with the required profile. In addition, variants of these techniques comprise in particular the action of pressures via counter-moulds that may be limited to some sections of the periphery of the glazing.

In these techniques care must be taken to ensure that the glass sheets only touch the bending frame (or the counter-moulds) on their periphery to minimise marls left on their surface. These marks, which cannot be completely avoided, are located in the zones where these glazing units are fastened to the vehicle body, and are practically imperceptible to the user.

Outside these sections located at the edge of the glazing units, the surface of the glass sheets is normally devoid of any mark caused by the softened glass coming into contact with any object.

In order to form the compound glazing with two perfectly matched sheets, these two sheets are systematically bent simultaneously. For this, the two sheets are disposed one on top of the other on the same bending frame. In this arrangement, a powder of very fine particles is distributed between these two sheets to prevent contact between the faces of the superposed sheets. The powder used is inert under the treatment conditions used and is removed by simple washing after the bending operation. In particular, this consists of calcium carbonate powder. The granulometry of the powder applied is fine enough, some tenths of microns, to leave no trace on the faces of the sheets in contact with it.

The application of thin functional layers to glazing units generally requires additional precautionary measures. The most usual layers, in particular for windscreens, are those reflecting infrared radiation. They are composed of an assembly comprising one or more infrared reflective metal layers and oxide dielectric layers, which protect the metal layers and restrict reflections in the visible wavelength range. The metal layers are formed by vacuum deposition techniques. These techniques result in highly uniform deposits of very low thickness. The layers in question are relatively sensitive as a whole to thermal stresses in particular. The increase in temperature to the appropriate level for softening the glass necessary for bending can cause changes in the composition or in the structure, which, even if very limited, often have an effect on the appearance of the glazing. These changes are, for example, the formation of marks, cloudy patches or parasitic colorations, which render these glazing units unsuitable for the use for which they were intended.

The layers in question are additionally relatively sensitive to mechanical stresses. In laminated-glazing units this causes them to be arranged on the inside faces of the glass sheets, in other words, those that are protected by the glass sheets themselves. Consequently, in the bending process the functional layers are arranged on the faces in contact with one another. In practice, in this position suitably selected layers can withstand the thermal conditions necessary for bending without deteriorating as far as they remain in contact only with the glass and the interposed inert separating powder outlined above.

Moreover, windscreens are currently glued to vehicle bodies, in particular to allow flush assembly, in which the profile of the glazing is a continuation of that of the vehicle body. This method of fastening requires the glue joint to be protected from degradation that could cause exposure to uv radiation. For this purpose, the glue joint is covered, and this is traditionally achieved by placing a strip of opaque enamel over the periphery of the glazing. This strip also plays an aesthetic role by concealing the glued joint, which would be visible through the glazing without it.

The use of functional glazing units also makes it necessary to conceal the elements associated with these functions as much as possible under these enamel patterns, in particular electrical conductors in the case of glazing units comprising elements for heating the glazing.

If, for the purposes of facilitating production, the enamel patterns were initially arranged on the face that is traditionally designated “IV”, i.e. the face turned towards the interior of the vehicle, the requirement to conceal these additional elements would require the enamel to be provided on the “inside” face of the laminated assembly, more precisely on the “II” face thereof.

The production of enamel patterns on glazing units is performed by applying a fluid composition, which must undergo a drying process and a curing process to fix the constituents thereof. The initial composition is applied by screen printing or any other method, in particular by inkjet printing.

With respect to enamel patterns, the following description refers to masking patterns arranged mainly on the periphery of numerous “automotive” glazing units. The technique according to the invention nevertheless concerns all enamel compositions applied to glazing units. For example, this concerns compositions intended to form heating filaments and containing a high proportion of a conductor metal. It also concerns compositions used for the formation of antennae enclosed in these glazing units, and generally all enamel patterns inserted between two glass sheets before they are subjected to a bending operation.

The treatment of enamel patterns is dependent on the composition used. These compositions all have elements of the same nature. These are essentially mineral pigments associated with a frit or a mixture of glass frits. These solid elements are mixed with solvents and diluents, which give the fluidity required for application. Polymer compounds are also generally present, which ensure the temporary fixing of the solid elements after removal of the solvents and before fusion (sintering) of the frit. The operation for forming the enamel in fact comprises a step, during which as the temperature rises, the different particles of the mixture composing the frit progressively fuse as a function of their individual composition. The progressive fusion of the particles retains a certain porosity of the assembly and this facilitates the vaporisation of the broken down organic constituents. Simultaneously with the fusion of the particles (sintering), crystallisation of the final product is triggered and the enamel progressively becomes “non-tacky”.

The drying of the patterns corresponds with the removal of the most volatile constituents and allows stabilisation with respect to subsequent handling. It is achieved at low temperatures. These are selected primarily so that the operation can proceed quickly. In practice, temperatures of 250° C. or less are preferred.

The removal of the polymer binders is conducted at higher temperatures. This removal corresponds with the destruction of the polymers and is achieved at temperatures usually above 200° C. The removal proceeds more quickly when the temperature is higher. It can be considered that above 400° C. all the organic constituents have been destroyed and only mineral, frit and pigment components remain.

For obvious reasons, it is desirable to utilise the passage through the bending ovens to assure thermal treatments of the enamelling composition, in particular those that require the highest temperatures.

This standard practice does not cause any difficulty when the enamelling composition is located on face IV. In this position the enamel is on the upper face in the bending operation. It is only in contact with the atmosphere of the oven. The volatile constituents are therefore evacuated without any difficulty. Moreover, in this position the enamel is not in contact with any other element, to which it could adhere, since the frame supporting the sheets is in contact with face I and the glass sheets rest on one another at their faces II and III.

When the enamel has to be in position II for the reasons indicated above, various difficulties are raised in practice. Those that are most apparent relate to the functional layers also present. The bending, for example, of a pair of sheets with enamel patterns and functional layers such as an antisolar layer and/or a heating layer arranged on faces II and III thereof often leads to deteriorations in the functional layer as well as the enamel patterns. The reasons for these changes have not be fully determined.

Faults can result from a transfer through contact-of a portion of the enamelling composition. This transfer is possible while “crystallisation” of the enamel has not been accomplished. As indicated above, the change in nature that accompanies the sintering results in a structure with characteristics that render it much more resistant to elevated temperatures. The composition becomes less “sticky” while adhering strongly to the sheet, to which it is applied.

These faults also result from the modification of the functional layers generally attributed to the presence of the constituents of the enamelling composition which are removed during curing. These are primarily binders and residues of solvents, which produce a reductive atmosphere that is detrimental to the integrity of the function layers at the treatment temperatures.

To avoid these faults, one solution consists of “pre-curing” the enamel patterns in an oven, where only the sheets with the patterns are inserted. The operation is very costly overall. It requires the use of ovens in addition to those for bending. It also involves an additional cycle of treatment of the sheets at elevated temperatures and returning these to ambient temperature to enable the handling that precedes the process of superposing the sheet bearing the enamel patterns on that bearing the functional layers.

The inventors have determined as objective the utilisation of techniques for bending on frames for laminated glazing units, in particular those having functional layers and enamel patterns, that will enable the faults of traditional techniques to be avoided, while not requiring enamelled sheets to be passed through a pre-curing oven. This objective was achieved by proceeding with the bending in conditions that allow the two superposed sheets to be kept at a distance from one another until the constituents of these enamels, which have been evacuated or destroyed during the thermal treatment of the bending operation and fusion of the particles, have been removed, so that the composition is no longer sticky.

The two glass sheets in the process according to the invention are arranged at a restricted distance from one another. The distance must be sufficient to enable the volatile products to be evacuated quickly through the space left between the sheets. Conversely, it is as short as possible so as to prevent any disadvantages that could result from too significant a distance, when in particular the two sheets are brought back into contact with one another after the removal of the volatile residues and sintering. It is also preferable that the two sheets are not spaced too far apart, so that the thermal conditions to which they are subjected, whether through radiation or convection, differ as little as possible.

The space between the sheets can be reduced further when the enamel patterns are located on the periphery of the glazing, the escape of the products released between the two sheets to the atmosphere of the oven being relatively quick even if the space between the sheets is limited.

In practice, it is preferable to maintain the distance of one above the other at less than 5 cm and preferably less than 3 cm. A minimum distance is still necessary, this taking into account in particular the geometry of the sheets, their dimensions and the extent of the enamel patterns. The distance is still sufficient to allow the elements temporarily supporting the upper sheet to be positioned. On the basis of these considerations, the distance is preferably not less than 5 mm and is advantageously 1 cm or more.

The spacing of the sheets does not necessarily relate to the entire extent of the sheets. The important factor for implementation of the process according to the invention is that the spacing of the sheets is performed in the zones likely to have the faults discussed above. Consequently, it may be sufficient to ensure that only the portions bearing the enamel patterns are subject to these measures.

Similarly, the distance between the sheets is not necessarily uniform over their entire extent. This distance can be adapted in relation to the magnitude of the enamelled zones concerned. Moreover, the fact that the sheets are supported at very localised points can result in variable distances depending on the distance between the points of support. In the case of very large sheets, the natural flexing as a result of their own weight, even when the sheets have not as yet softened as a result of the elevation in temperature, can cause the zones of the sheets furthest from the points of support to move closer.

This effect can also be used as a matter of course to ensure that the central zones of the sheets, which do not usually have enamel patterns, move closer and even come into contact, while the edges of these same sheets are distant from one another.

The difference in distance depending on the zones of the sheets is achieved, for example, by supporting the upper sheet and that resting on the frame at localised points in the various positions. As a further example, at the entrance to the bending oven the lower sheet usually rests on the articulated frames not only at its ends but also at the articulation points. In these conditions, if the upper sheet is only supported at the ends, it tends to flex at the centre to move closer to the sheet supported by the frame, as the distance between the points of support is essentially more significant for this upper sheet.

The sheets are bent in an oven by undergoing a progressively conducted heat treatment. The retention time in the oven takes into consideration in particular the thermal inertia of the glass, the need to prevent the sheets from being subjected to excessive thermal shock, as well as the deformation kinetics when the appropriate temperature has been reached.

The process of increasing temperature is progressive up to the softening temperature. For the glass sheets most frequently used to form these glazing units, the shaping temperature lies between 550° and 680° C. When the glass sheets reach these temperatures the organic constituents of the enamelling compositions are completely destroyed, and the enamels are sintered. Therefore, they no longer constitute a risk and the sheets that were initially separated can be brought together again.

In practice, it is preferable to bring the sheets back together as soon as possible after the removal of the organic constituents is completed, and advantageously when the enamel patterns have not been sintered. As a result, virtually the whole of the shaping step of the sheets is held until after they have been joined together again. In these conditions, the two sheets undergo identical bending.

Bringing the sheets together after sintering prevents instances of transfer from the composition of one sheet to another. The crystallographic characteristics of the enamel are greatly modified by sintering, in other words by proceeding with the fritting thereof. The compositions used for these applications are such that after sintering, the enamel no longer softens at the temperatures reached during bending. The patterns adhere firmly to the sheet to which they are applied and can no longer stick to the other sheet.

Taking into consideration the kinetics of the increase in temperature of the sheet, of decomposition of the organic residues and of sintering the enamelled compositions, the re-joining of the sheets is preferably conducted when the temperature reaches at least 400° C. and preferably at least 450° C. The sheets should preferably not be re-joined beyond 580° C. and preferably not above 550° C.

The temperatures, at which the re-joining of the sheets is commenced, are quite obviously dependent on the rate of temperature increase. As the rate of this increase in temperature is raised, more organic residues are removed and more enamel is sintered at an elevated temperature and vice versa.

The invention aims to avoid the treatment of pre-curing the enamel patterns. Usually, the sheets bearing these patterns would be dried beforehand, as indicated above, at relatively low temperatures. It is also possible to proceed directly with drying in the bending oven while taking precautionary measures during handling of the sheets so that the enamel patterns are protected from any contact at the time when they are not “fixed” to the sheet.

The inventors have also developed means to enable the bending process according to the invention to be conducted. These means comprise bending frames having elements that allow two glass sheets to be disposed in a superposed arrangement at a distance from one another during a first phase and these two sheets to be re-assembled in a second phase.

A mode of operation consists of arranging elements on a bending frame to support the upper sheet on its periphery. The elements are arranged so that the lower sheet rests on the frame itself, while at the start of the bending process the upper sheet sits on additional supports located above the frame.

The support means can be removed at the appropriate time to release the upper sheet as it comes to rest on the sheet supported by the frame.

The contact of the upper sheet with the temporary support elements is restricted to the immediate periphery of the sheet to avoid the risk of any marks resulting from the contact.

The supports of the upper sheet can ensure a hold on a very limited portion of the periphery utilising the rigidity of the sheet. The softening and shaping of the upper sheet does not occur, or only occurs to a limited degree, while the sheet is resting on these supports. A substantial part, if not all, of the “shaping” occurs when the sheets are re-joined and rest together on the frame. In these conditions, the use of a limited support, or one restricted to some points, does not compromise proper shaping.

The ease of use of these support means causes elements to preferably be arranged discretely at points that assure the least amount of flexing of the sheet under the effect of its own weight before it reaches the softening temperature.

The invention is described below with reference to the set of attached drawings, wherein:

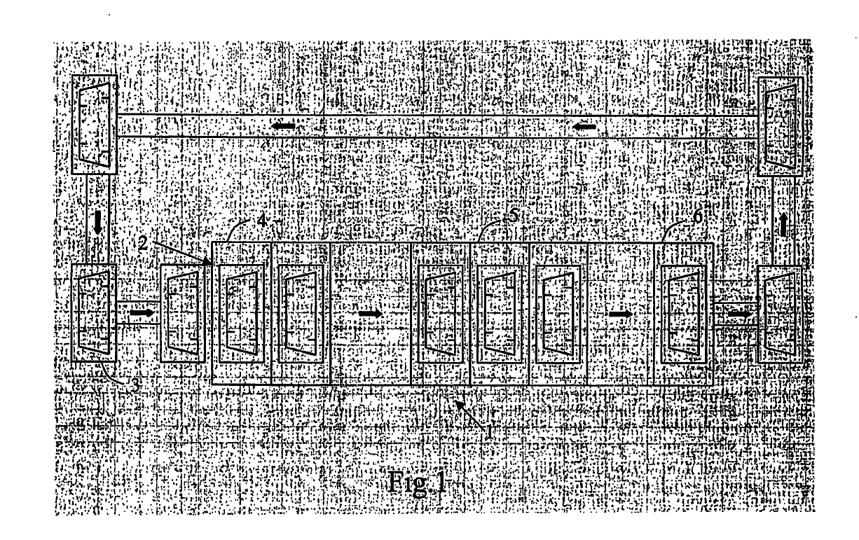

FIG. 1 is a diagram representing the circulation in the bending oven and the different stages corresponding to the process according to the invention;

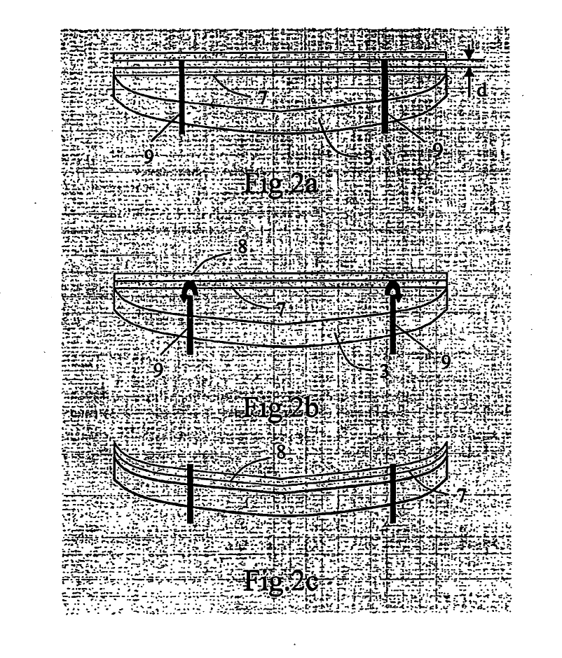

FIGS. 2a, 2b, 2c are schematic views in vertical section of different periods in the bending process according to the invention;

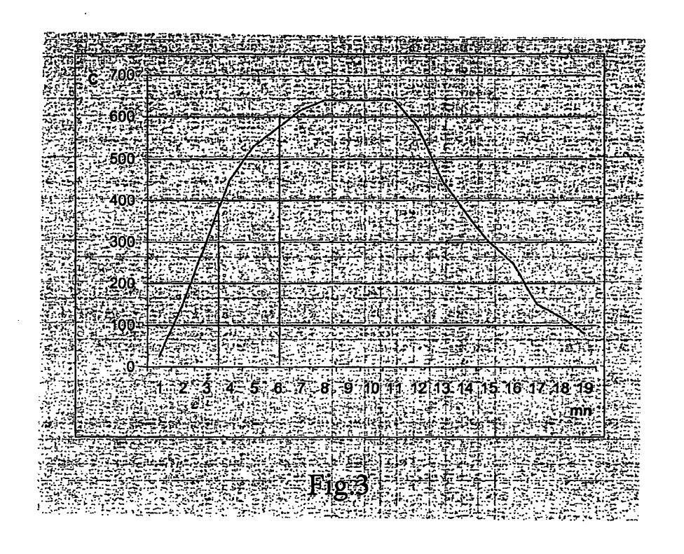

FIG. 3 is a graph showing a temperature cycle in a bending oven;

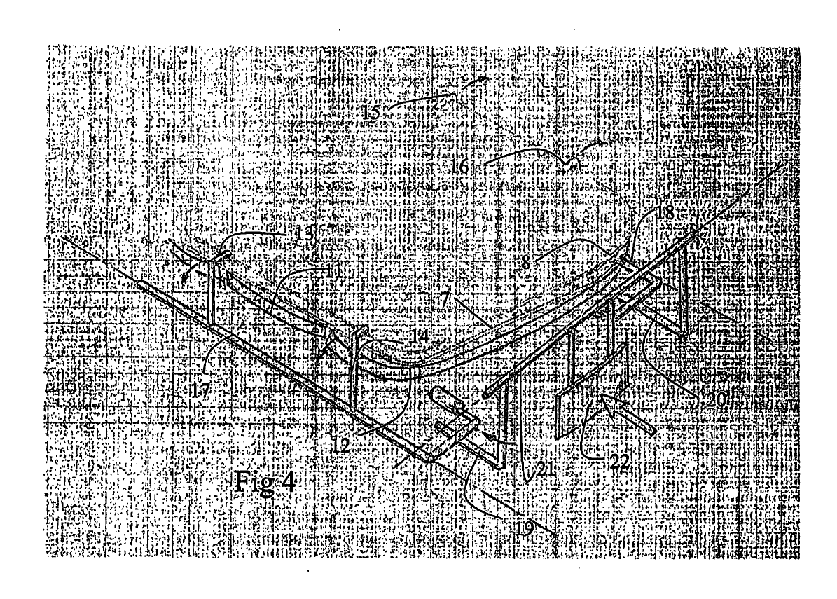

FIG. 4 is a schematic perspective view of an embodiment of the frame used according to the invention.

The diagram in FIG. 1 shows the movement of the glass sheets subjected to a bending operation through gravity in a “tunnel” type oven. The oven is given the overall reference 1 here.

In installations of this type, the sheets to be bent enter the oven 1 at one of its ends 2. The sheets are supported by bending frames 3, which continuously circulate along the path indicated by arrows. The glass sheets are not shown on the diagram.

In traditional techniques the two sheets are placed simultaneously on the frame one on top of the other and they only come into contact by way of the separation powder.

The frames usually used to shape highly curved glazing units generally comprise several articulated sections to facilitate transport and adequate support of the sheets during this significant geometric transformation. The measures of the invention apply equally to fixed frames and to articulated frames. They also apply to frames comprising elements that are used in succession to support the sheets during the bending process, such as those described in the patent application EP 885 851. These latter frames are used to separately generate curvatures in two directions, one corresponding to the length and the other to the width of these glazing units.

It should be noted that if several supports are used in succession according to the invention, these supports are not applied to the two sheets simultaneously, but to each separately. The means and their roles are therefore different to those of the patent application EP 885 851.

The frames supporting the sheets advance in the oven step by step, as shown in the diagram in FIG. 1, or continuously, and in a first section 4 are subjected to a temperature that rises continuously.

The duration of the rise in temperature is dependent on the particular characteristics of each glazing model. For current windscreens the time for the rise in temperature to achieve softening of the glass varies between about 4 and 10 minutes.

Once these softening temperatures are reached in section 5 of the oven, the temperature mostly continues to increase, but less quickly, to a set level. The retention time at these temperatures is dependent on the degree of bending sought. It increases as the curvature increases.

In the case described in patent application EP 885 851, comprising the separate shaping of curvatures in two directions, the shaping of the second curvature is actuated in this period when located in the softening zone. To conduct this separate curvature, the sheets are brought, if necessary, to a second temperature level higher than that of the first set level.

When the sought curvatures have been accomplished, the sheets are quickly brought back to a lower temperature than the softening temperature in a section 6 of the oven, and this solidifies the glass and prevents any subsequent deformation. The cooling is conducted quickly, but without leading to toughening, which is not necessary for laminated glazing units.

The bent glass sheets exiting from the oven are removed from the frame for subsequent assembly. The frames 3 return to the starting position for a new operation.

The diagrams in FIG. 2 illustrate the mode of operation according to the invention.

The operation of the invention differs from the traditional technique in that the sheets entering the bending oven are supported by the frame 3 itself in the case of the sheet in the lower position 7 and by additional temporary support means 9 in the case of the sheet in the upper position 8.

For clarity and simplicity in the drawing, the frame is shown as a fixed frame. The same measures nevertheless apply to an articulated frame or a frame for successive support.

FIG. 2a shows the arrangement of the two sheets on entering the oven. The lower sheet 7 rests on the ends 10 of the frame 3, while the sheet 8 is supported by elements 9. In this arrangement, the two sheets are held separate from one another at a distance d. Their relative rigidity ensures that the sheets are not in contact, even when supported at localised points, as shown.

This arrangement is maintained, as indicated above, for as long as necessary to sinter the enamel and evacuate the decomposition products of the organic components of the enamel patterns. These patterns in position II are located on the lower sheet 7 on the face facing upwards, while the functional layers are borne by the upper sheet 8 on its face facing downwards.

When the enamel is sintered and all the organic components have been eliminated, the supports 9 are simultaneously set aside. The released sheet 8 comes to rest on sheet 7 (FIG. 2b). This operation is performed before the softening of the sheets has led to a significant deformation thereof, so that the two sheets have the very same profile and are resting on one another over their entire surface.

FIG. 2c relates to the end of the bending process. The two sheets 7 and 8 are flexed and come to rest on the periphery of the frame 3. Their contour therefore corresponds exactly to the profile generated by the shape of the frame.

The situation is the same for articulated frames, but the glass sheet 7 usually rests not only on the ends 10, but also at points corresponding to the ends of the fixed section of the frame and/or at the points where the movable elements connect to the fixed section. However, the same type of support for the upper sheet can be used in both cases.

The diagrams in FIG. 2 show the point-type supports 9. The advantage of this configuration is that it minimises contact of the upper sheet with these elements. While their contact can cause slight marking on the function layer, this remains practically imperceptible, as it is concealed by the enamelled sections, and moreover these marls do not change the functionality of the layer in any way.

If, in an exceptional case, it is necessary to hold the sheets separate when they reach the softening temperatures, the supports 9 must rest on a significant portion of the periphery of the sheet 8 or at least at points sufficiently close to one another to properly hold the sheet 8 at a distance from sheet 7 over their whole periphery. The multiplicity of support points is nevertheless a complicating factor and is preferably avoided.

The actuation of the removal of the support means 9 is advantageously achieved by a set of rods and bars (not shown), which are actuated at the desired time during the advance of the frames. One method of actuation consists of a pushing means integral to the rods and bars. When the appropriate stage in the advance is reached, a piston pushes against the pushing means, which causes the rods to pivot. The rotation of the rods causes a lateral displacement of the ends of the supports 9 towards the outside of the sheet 8, which when released from its support comes to rest on the sheet 7 arranged immediately below it.

FIG. 3 illustrates the bending process according to the invention on the basis of the thermal cycle the windscreen is subjected to. The graph in FIG. 3 shows the development of the temperature of the sheet over time throughout the retention period in the bending oven.

In the selected example, the two treated glass sheets are formed from clear glass with a thickness of 2.6 mm.

This is the treatment cycle that is conducted on glazing units comprising on face II an enamel pattern primarily covering the contour of the glazing over a strip of about 8 cm in width as well as, in the high section and in the middle of this, an extension of the enamel strip intended to conceal the respective locations of the seating of the rear vision mirror and elements associated with the provision of a rain sensor.

The composition of the enamel applied is that sold under the commercial designations “RD₄₇₉ MS089” by Johnson Matthey. The viscosity of the composition is adjusted by means of the diluent 726-80 from the same company to establish the viscosity at 19 Pa·s. The composition applied by screen printing forms a film with a thickness of 20 μ in moist state.

The film is dried through movement through a pre-drying oven at 250° C. for 70 seconds. After this drying operation, the sheets are directed towards the bending oven to be joined with the sheets bearing the functional layers.

The functional layers are those for reflecting infrared radiation. This is an assembly of layers such as those concerned in patent EP 336 257. These layers comprise two silver layers enclosed and separated by dielectric oxide layers, which restrict the reflection of visible radiation. The dielectric layers also provide protection for the silver layers. They additionally allow adjustment of the colours in reflection which dictate the appearance of these glazing units.

The layer assembly is located on the sheet which corresponds to face III in the final glazing.

When loading the bending moulds, the sheets bearing the previously dried enamel patterns is arranged on the support points of the mould itself, as shown in 2a, the patterns being on the face that is not in contact with the mould. The sheet bearing the functional layers is placed on the support elements with its functional face facing downwards. The sheets are 20 mm apart.

The reported temperature is that measured in the centre of the glazing. The differences in temperature to the end edges are as small as possible. In the conducted tests, the temperature of both sides was slightly less than that of the centre in the phase of temperature increase. The difference did not exceed 20° C.

The temperature rise is rapid. It is about 500° C. after 3 mins. 30. The temperature level of about 630° C. is reached after 6 mins. This temperature is maintained for 4 mins. The end of the cycle comprises a cooling that is equally rapid, the temperature of 500° C. being reached again less than two minutes after the end of the set level.

Entered on the graph are vertical lines defining the zones, in which according to the invention the support elements are preferably spaced to release the upper sheet that has come to rest on the lower sheet. In the example, the two ends defining this zone correspond approximately to the temperatures of 400° C. and 580° C. Sintering is completed in the interval shown. The enamel pattern becomes more stable, the longer the period before the sheets are re-assembled. Conversely, this re-joining of the sheets should not be left too long so that they will not deform independently of one another.

FIG. 4 schematically shows an embodiment of a frame usable to implement the invention.

The frame shown is an articulated type. It comprises elements fixed in longitudinal directions 11 and lateral sections 12 that are rotatably movable. The sides of the frame are intended to be raised under the effect of counterweights (not shown) while the glass is softening and does not exert sufficient pressure on the side edges. This type of frame is used for glazing units that have a relatively significant curvature along the length of the glazing.

The support elements of the upper sheet 13, 14, 15, 16 are located on either side of the largest dimensions of the glazing. Their position is such that the sheet is subjected to the least possible flexing under the effect of its own weight when cold. The drawing comprises 4 support points. If the sheets are of large dimensions, it may be preferable to add other additional points to the arrangement following the same operating principle.

The arrangement shown does not have any support points on the small sides of the glazing. If the dimensions justify it, the same type of support can also be used along these small sides.

The supports are formed from essentially vertical rods bent at their ends. These rods are welded to rods 17 and 18. These rods form an axis of rotation, which allows the supports to be moved in the direction indicated by the arrows at the selected time to place the upper sheet on that resting on the frame.

The movements of rods 17 and 18 is assured by a set of bars 19 and 20. The bars 19 and 20 are themselves fixed at an axis 21 set in rotation as a result of the movement transmitted by the pushing means 22.

By pressing on the pushing means 22, the transmitted movement lifts the bars 19, 20, causes the rods 17, 18 to pivot and the vertical supports 13, 14, 15, 16 to swivel and release the upper sheet.

1. Process for bending on a frame glass sheets intended for assembly forming a laminated glazing unit, at least one of the sheets bearing patterns of enamelling composition that have not been pre-sintered, the other sheet bearing functional layers, the enamel patterns and the functional layers being on the faces of the sheets in contact with one another, characterised in that, during passage through the bending oven, in a first time phase, the sheets are arranged one on top of the other while maintaining a space between them for the period corresponding to sintering under the action of increasing temperature, then before the temperature for softening the sheets has been reached, these are put back one directly on top of the other for the remainder of the bending operation.

2. Process according to claim 1, wherein in the first time phase, the sheets are held at a distance from one another that does not exceed 5 cm.

3. Process according to claim 1, wherein in the first time phase, the sheets are held at a distance from one another that does not exceed 3 cm.

4. Process according to claim 1, wherein in the first time phase the distance separating the sheets is not less than 5 mm.

5. Process according to claim 1, wherein in the first time phase the distance separating the sheets is not less than 10 mm.

6. Process according to claim 1, wherein the sheets are put back one on top of the other at a temperature that is not higher than 580° C.

7. Process according to claim 1, wherein the sheets are put back one on top of the other at a temperature that is not higher than 550° C.

8. Process according to claim 1, wherein the sheets are put back one on top of the other at a temperature that is not lower than 400° C.

9. Process according to claim 1, wherein the sheets are put back one on top of the other at a temperature that is not lower than 450° C.

10. Process according to claim 1, wherein the sheet bearing the enamelling composition is subjected directly to the bending process directly after application of these patterns.

11. Process according to claim 1, wherein the sheet bearing the enamelling composition is subjected to a drying operation prior to bending, the temperature and the drying time being insufficient to eliminate all the organic constituents.

12. Bending frame for implementing the process according to claim 1, which, in addition to the frame having for the purpose of the operation the profile of the desired glazing and said frame supporting one of the two sheets at the beginning of the bending process, comprises elements enabling the second glass sheet to be supported at a distance above the first sheet, during a first time phase, then, in a second time phase, these same means may be moved away to release the second glass sheet, which then comes to rest on the first sheet.

13. Frame according to claim 12, wherein the support elements are arranged on the periphery of the sheet to support the sheet over at least one section of the periphery so that the upper sheet hardly flexes and maintains an adequate distance over its entire surface from the lower sheet.

14. Bent laminated glazing obtained through the process according to claim 1.
